(19) United States
(12) Patent Application Publication
(10) Pub. No.: US 2025/0148712 A1
(43) Pub. Date: May 8, 2025

(54) METHODS AND SYSTEMS FOR DIGITAL CONTENT CREATION

(71) Applicant: Magic Unicorn Inc., Wilmington, DE (US)

(72) Inventors: Anatolii Belikov, Berlin (DE); Vladislav Marenov, Elektrostal (RU); Dmitrii Sukhorukov, Voskresensk (RU)

(21) Appl. No.: 18/386,743

(22) Filed: Nov. 3, 2023

(51) Int. Cl. G06T 17/20; G06T 17/30

(52) U.S. Cl. CPC G06T 17/20; G06T 17/30

(57) ABSTRACT

Provided for are systems and methods for digital content creation, including systems and methods for creating digital assets for metaverse applications. The systems and methods generally provide for constructing digital content using deformable procedural primitives. The described systems and methods advantageously separate a design or asset from a required level of detail so that the created asset may be efficiently generated at the required level of detail. The described systems and methods also solve interoperability issues in order to provide content which is cross-accessible by various metaverse platforms while maximizing the quality of the asset in each platform.

### FIELD OF THE INVENTION

Provided for are systems and methods for digital content creation, including systems and methods for creating digital assets for metaverse applications. The systems and methods generally provide for constructing digital content using deformable procedural primitives. The described systems and methods advantageously separate a design or asset from a required level of detail so that the created asset may be efficiently generated at the required level of detail. The described systems and methods also solve interoperability issues in order to provide content which is cross-accessible by various metaverse platforms while maximizing the quality of the asset in each platform.

### BACKGROUND OF THE INVENTION

Metaverse technologies are rapidly growing and projected to reach an $800 billion market value by 2024. WEB 3.0 is the proliferating decentralized internet platform which can support various metaverse technologies, including secure digital content or assets. An aspect of the metaverse/WEB 3.0 includes secure minting, ownership, and sales of digital content or assets created by individuals by way of decentralized ledgers such as blockchain technologies.

While virtual reality, gaming, social networking, and other technologies in the WEB 3.0 world are rapidly expanding, there are compatibility and cross-accessibility issues in the context of 3D digital content or assets. 3D assets (such as avatars, characters, etc.) are typically created with traditional technologies that are not compatible across multiple metaverse platforms, meaning that assets and commerce remain closed within particular metaverse platforms. Therefore, new 3D asset technologies should overcome this interoperability issue between metaverse platforms.

Additionally, existing 3D content creation technologies require tedious topology modeling to create or edit 3D assets. While some sculpting tools exist to remove some burden from the creator by avoiding topology modeling, such tools are inoperable outside their own metaverse platforms. Another ineffective option is traditional auto-retopology of an asset to generate a topological model-however there is a high loss of quality as well as loss of texture where traditional auto-retopology is applied.

A solution to these issues, as described herein, are primitives-based content creation platforms. The described systems and methods employing these platforms allow for instant, automatic detailing scalability of polygons and textures to allow 3D assets to run on all platforms and devices. More precisely, the described methods and system provide for, in part, separating a design or asset from a required level of detail for a given platform so that the asset may be generated at the required level of detail. By avoiding traditional topology modeling, the systems and methods provide streamlined content creation platforms which also solve interoperability issues in order to provide content which is cross-accessible by various metaverse platforms while maximizing the quality of the asset in each platform.

### SUMMARY OF THE INVENTION

Accordingly, the present disclosure provides for systems and methods for digital content creation. Various non-limiting exemplary embodiments are described herein. Further embodiments within the spirit and scope of the present disclosure are contemplated, which may include various aspects of the exemplary embodiments and the present disclosure.

In an embodiment, the present disclosure provides for methods for digital content creation, comprising one or more steps of:
overlaying one or more primitive shapes in a first coordinate system, each of the one or more primitive shapes being additive or subtractive, to generate an analytical overall surface defined by subtraction of subtractive primitive shapes from a sum of additive primitive shapes;
determining a resolution step, the resolution step having a geometric magnitude corresponding to a smallest desired feature of the analytical overall surface;
segmenting the analytical overall surface to obtain one or more shells which are geometrically larger than the resolution step, each shell having a border with vertices, the vertices being spaced apart by a distance of about less than or equal to the resolution step;
flattening the one or more shells from three dimensions to two dimensions by projecting the one or more shells onto a respective normal plane aligned on a second respective coordinate system;
generating a number of concentric isolines in the one or more flattened shells;
populating the concentric isolines in the one or more flattened shells with vertices being spaced apart by a distance of about less than or equal to the resolution step;
identifying one or more portions of concave curvature and one or more points of convex curvature in the one or more flattened shells,
meshing the one or more flattened shells to produce meshed, flattened shells by forming connections between adjacent vertices such that the connections between adjacent vertices in the respective flattened shells define respective pluralities of four-sided shapes within the borders of the respective flattened shells, wherein the connections generally pass through portions of concave curvature of the respective flattened shells and wherein the connections generally avoid portions of convex curvature of the respective flattened shells;
unflattening the meshed, flattened shells from two dimensions to three dimensions; and
aligning the meshed, unflattened shells in the first coordinate system to generate a meshed analytical overall surface.

In an embodiment, the concentric isolines of the respective flattened shells are spaced apart by at least a distance of resolution step*2.

In an embodiment, circles having a radius of the resolution step are placed between concentric isolines such that a given concentric isoline does not intersect a given circle at more than one point.

In an embodiment, regions of the concentric isolines of a given shell which are smaller than a circle having a radius of the resolution step are collapsed into line segments defined a start vertex and an end vertex.

In an embodiment, the respective portions of concave curvature include a concave extreme vertex, and wherein the respective portions of convex curvature include a convex extreme vertex.

In an embodiment, the border of each of the one or more shells is defined by line segments terminated by joint points, each joint point being shared by two line segments.

In an embodiment, a shell may have an odd number of joint points or an even number of joint points.

In an embodiment, for every first shell having an odd number of joint points, a second shell having an odd number of joint points is present.

In an embodiment, for every first and second shell having an odd number of joint points, a border point is added on an edge of the first and second shells to produce an even number of points on each of the first and second shells.

In an embodiment, the present disclosure provides for systems for digital content creation comprising:
a mobile computing device comprising
   a processor operably coupled to transitory memory, wherein the processor is operable to obtain computer-readable instructions from a non-transitory data store of the mobile computing device or from a non-transitory data store accessible over a network connection of the mobile computing device, and wherein the processor is operable to load said computer-readable instructions to said transitory memory for execution by said processor;
an application including a graphical user interface comprising user prompts operable to instruct the processor to execute selected computer-readable instructions, wherein the graphical user interface is operable to perform one or more steps of:
   overlaying one or more primitive shapes in a first coordinate system, each of the one or more primitive shapes being additive or subtractive, to generate an analytical overall surface defined by subtraction of subtractive primitive shapes from a sum of additive primitive shapes;
   determining a resolution step, the resolution step having a geometric magnitude corresponding to a smallest desired feature of the analytical overall surface;
   segmenting the analytical overall surface to obtain one or more shells which are geometrically larger than the resolution step, each shell having a border with vertices, the vertices being spaced apart by a distance of about less than or equal to the resolution step;
   flattening the one or more shells from three dimensions to two dimensions by projecting the one or more shells onto a respective normal plane aligned on a second respective coordinate system;
   generating a number of concentric isolines in the one or more flattened shells;
   populating the concentric isolines in the one or more flattened shells with vertices being spaced apart by a distance of about less than or equal to the resolution step;
   identifying one or more portions of concave curvature and one or more points of convex curvature in the one or more flattened shells,
   meshing the one or more flattened shells to produce meshed, flattened shells by forming connections between adjacent vertices such that the connections between adjacent vertices in the respective flattened shells define respective pluralities of four-sided shapes within the borders of the respective flattened shells, wherein the connections generally pass through portions of concave curvature of the respective flattened shells and wherein the connections generally avoid portions of convex curvature of the respective flattened shells;
   unflattening the meshed, flattened shells from two dimensions to three dimensions; and
   aligning the meshed, unflattened shells in the first coordinate system to generate a meshed analytical overall surface.

In an embodiment, the user prompts include selecting a first primitive shape, placing the selected first primitive shape, selecting a second primitive shape, and placing the selected second primitive shape.

In an embodiment, the user prompts include sculpting a primitive shape by making a stroke in the graphical user interface to offset an analytical surface of the primitive from a default analytical surface of the primitive.

In an embodiment, the offset is stored as a two-dimensional map in a coordinate system of the primitive.

In an embodiment, the offset includes a plurality of points, each of the plurality of points including an offset direction and offset value.

In an embodiment, the present disclosure provides for methods for digital content creation, comprising one or more steps of:
overlaying one or more primitive shapes in a first coordinate system, each of the one or more primitive shapes being additive or subtractive, to generate an analytical overall surface defined by subtraction of subtractive primitive shapes from a sum of additive primitive shapes;
determining a resolution step, the resolution step having a geometric magnitude corresponding to a smallest desired feature of the analytical overall surface;
segmenting the analytical overall surface to obtain one or more shells which are geometrically larger than the resolution step, each shell having a border with vertices, the vertices being spaced apart by a distance of about less than or equal to the resolution step;
generating a number of concentric isolines in the one or more shells;
populating the concentric isolines in the one or more shells with vertices being spaced apart by a distance of about less than or equal to the resolution step;
identifying one or more portions of concave curvature and one or more points of convex curvature in the one or more shells,
meshing the one or more shells to produce meshed shells by forming connections between adjacent vertices such that the connections between adjacent vertices in the respective shells define respective pluralities of four-sided shapes within the borders of the respective shells, wherein the connections generally pass through portions of concave curvature of the respective shells and wherein the connections generally avoid portions of convex curvature of the respective shells; and
aligning the meshed shells in the first coordinate system to generate a meshed analytical overall surface.

In an embodiment, the respective portions of concave curvature include a concave extreme vertex, and wherein the respective portions of convex curvature include a convex extreme vertex.

In an embodiment, the border of each of the one or more shells is defined by line segments terminated by joint points, each joint point being shared by two line segments.

In an embodiment, a shell may have an odd number of joint points or an even number of joint points.

In an embodiment, for every first shell having an odd number of joint points, a second shell having an odd number of joint points is present.

In an embodiment, for every first and second shell having an odd number of joint points, a border point is added on an edge of the first and second shells to produce an even number of points on each of the first and second shells.

### BRIEF DESCRIPTION OF THE DRAWINGS

Aspects and advantages of the present disclosure will become apparent from the following exemplary embodiments taken in conjunction with the accompanying drawings, of which:

FIG. 1 depicts an exemplary representation of a model created by additions and, optionally, subtractions of various shapes;

FIG. 2A depicts an exemplary application of a smoothing window to a primitive joint.

FIG. 2B depicts an example of smoothing of a primitive shape;

FIG. 3 depicts an example of a stroke input on a primitive to offset the analytical surface;

FIG. 4 depicts an exemplary representation of a resolution step;

FIG. 5 depicts an exemplary embodiment of an analytical surface and underlying primitive shapes;

FIG. 6 depicts an exemplary embodiment of shells being defined by the underlying primitive shapes of an analytical surface;

FIG. 7 depicts an example of a feature smaller than a resolution step being filtered out;

FIG. 8 depicts an exemplary embodiment of defining an area formed by intrinsic axes of an exemplary primitive;

FIG. 9 depicts an example of a grid analysis of a shell area;

FIG. 10 depicts an exemplary filtering procedure for a grid analysis;

FIG. 11 depicts an example of a minimal resolution prism having two odd-numbered shells;

FIG. 12 depicts an example of a model projected onto a plane having two odd-numbered shells;

FIG. 13 depicts an addition of vertices onto the exemplary model of FIG. 12 as described herein to produce an even number of vertices on all shells of the model;

FIG. 14 depicts an exemplary addition of pairs of vertices to the exemplary model of FIG. 13;

FIG. 15 depicts an exemplary separation of a shell from an analytical surface;

FIG. 16 depicts an exemplary flattening procedure applied to a three-dimensional shell;

FIG. 17 depicts an exemplary flattened shell from the procedure of FIG. 16;

FIG. 18 depicts an exemplary heat map created in a shell;

FIG. 19 depicts an exemplary shell with concentric isolines;

FIG. 20 depicts an exemplary procedure of placing markers to identify complex features;

FIG. 21 depicts an exemplary procedure for collapsing complex features into lines;

FIG. 22 depicts an exemplary procedure for determining a length of a collapsed line using a circle and the next-most isoline;

FIG. 23 depicts an exemplary procedure for placing vertices at the tip and base of collapsed lines;

FIG. 24A depicts an exemplary shell of FIG. 23;

FIG. 24B depicts the exemplary shell of FIG. 24A having its isolines seeded with sampling points;

FIG. 25 depicts an exemplary procedure for determining one or more concave extremes;

FIG. 26 depicts the placement of vertices where concave extremes have been identified;

FIGS. 27A-27D depicts exemplary representations of convex extreme placements according to an overall or accumulated angle where one (FIG. 27A), two (FIG. 27B), three (FIG. 27C) or four (FIG. 27D) convex extremes are added;

FIG. 28A depicts an overall angle where a convex extreme is to be placed;

FIG. 28B depicts placement of a convex extreme in accordance with a determined overall angle;

FIG. 29 depicts placement of convex extremes onto an exemplary shell;

FIG. 30 depicts an exemplary embodiment of determining a pyramid of an exemplary shell;

FIG. 31A-B depict pyramids having an even (FIG. 31A) and odd (FIG. 31B) number of both top and bottom vertices;

FIG. 32A depicts an exemplary pyramid having an even number of vertices at the bottom and an odd number of vertices at the top;

FIG. 32B depicts an exemplary procedure for modifying the connectivity of the pyramid of 32A for obtaining an even number of vertices at the top;

FIG. 33A-35B depict an exemplary procedure for filling a pyramid (FIG. 33A) with vertices (FIG. 33B);

FIG. 34 depicts an exemplary shell populated with vertices from pyramid procedures.

FIG. 35A-35B depict an indexed pyramid (FIG. 35A) having its quads connectivity determined (FIG. 35B);

FIG. 36 depicts an exemplary pyramid indexing and quad connectivity procedure for pyramids containing a convex extreme;

FIG. 37 depicts an exemplary embodiment of a second exemplary procedure having concave axes placed on an exemplary shell;

FIG. 38 depicts an exemplary embodiment of concave axes being placed on an exemplary shell;

FIG. 39 depicts an exemplary embodiment of vertex placement upon a shell having utilized concave and convex axes of a second exemplary procedure;

FIG. 40 depicts an exemplary embodiment of a shell meshed in quads; and

FIG. 41 depicts an exemplary embodiment of an overall analytical surface assembled from meshed quad shells of its primitives.

### DETAILED DESCRIPTION OF THE INVENTION

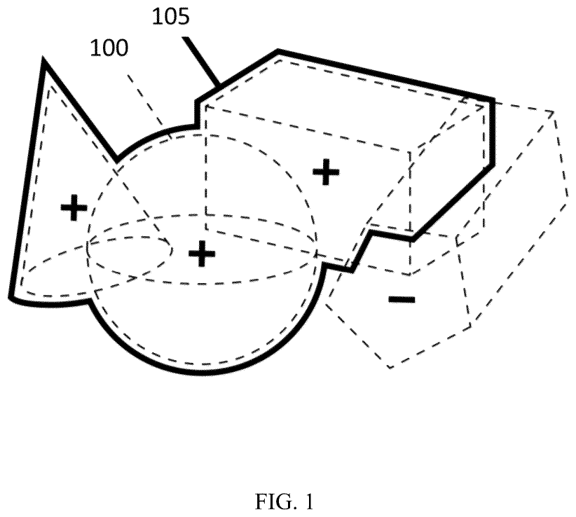

FIGS. 1-41 generally depict various embodiments of the present disclosure. While the figures and their accompanying description are organized in a manner which aids in clear description, it can be appreciated that various embodiments may employ various steps or aspects in different orders, or omit certain steps or aspects, so long as the embodiments are useful. While each figure utilizes reference numerals unique to the figure for clarity, it can be appreciated that similar referenced aspects or features may appear in a number of figures as described below.

In various embodiments, digital content is created using deformable procedural primitives. FIG. 1 depicts an exemplary representation of a model created by additions and, optionally, subtractions of various shapes. The dashed line primitive shapes 100, i.e. the deformable procedural primitives, are indicated with either a plus (+) or minus (−) to show whether the shape 100 will add to, or remove from, the continuous analytical overall surface 105 shown with a solid line. The procedural primitive shapes 100 are “deformable” because their dimensions may be altered to produce unique shapes. For clarity, in FIG. 1 and subsequent figures as will be clear to the reader, certain dashed and solid lines are shown adjacent but may be overlapping where the boundary of the continuous analytical overall surface (e.g., 105) is defined by a primitive shape (e.g., 100) boundary.

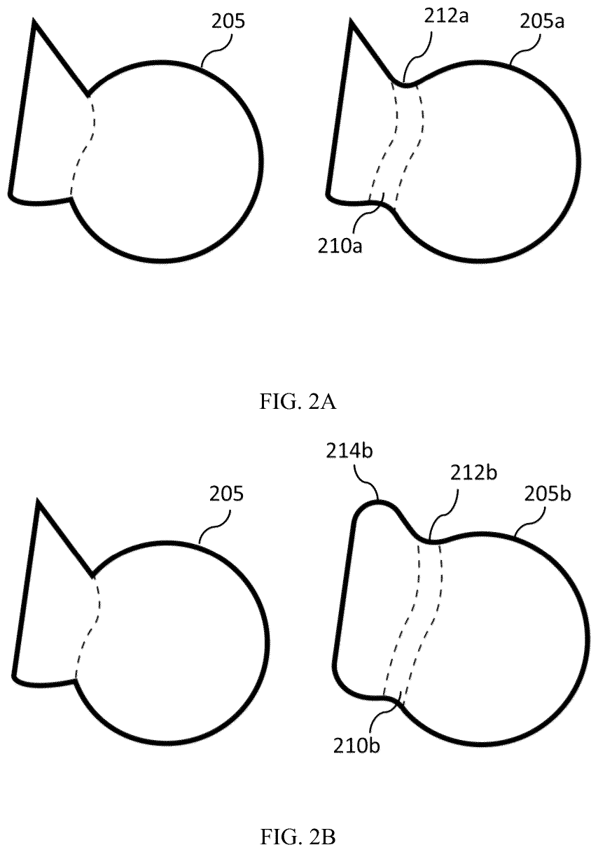

In various embodiments, the primitive shapes or continuous analytical overall surfaces (e.g. 205) may be deformed or smoothed to create a model. As depicted in FIG. 2A (left, unsmoothed and right, smoothed) a smoothing window 210a may be applied to smooth a primitive joint 212a. As depicted in FIG. 2B (left, unsmoothed and right, smoothed) a primitive shape may also be smoothed 114b. The user generally creates a model or continuous analytical overall surface 205 by combining and deforming various primitives to obtain a desired overall shape.

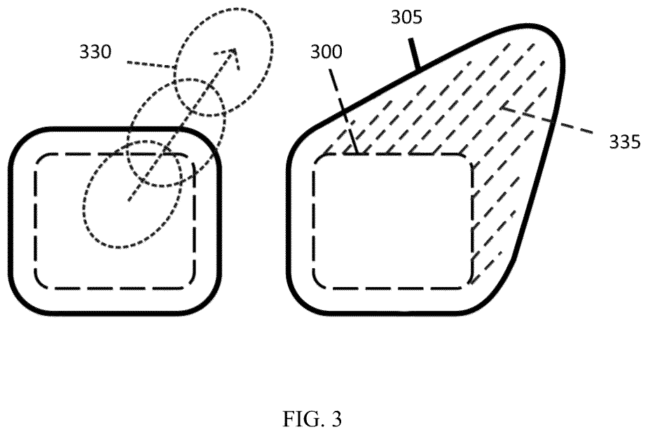

In various embodiments, sculpting may optionally be applied. For example, parts of a shape that can't be readily created by combining primitive shapes may be more efficiently produced by sculpting as an alternative means. In addition to efficiency, sculpting may minimize the number of primitive shapes (e.g., 300) required to produce a given continuous analytical overall surface 305, or model. Sculpting generally creates an offset of the overall analytical surface 305 based upon an underlying primitive shape 300. As depicted in FIG. 3, a user may make a stroke 330 on a primitive 300 which offsets the analytical surface 305. The stroke may be any type of input depending upon the particular user interface, such as a fingertip on a touchscreen or any other input effective to create an offset of the analytical surface. The offset 335 is stored as a 2-D map in the coordinates of the primitive shape 300, where each point on the map stores offset direction and value.

In an embodiment, the systems and methods utilize an analytical surface of a model stored in an infinite level of detail format which is compatible with various metaverse platforms. In an embodiment, topology (e.g., quads of triangles) is not created or stored until the moment of export via polygonal format or during rendering in a host system (such as a metaverse platform or server).

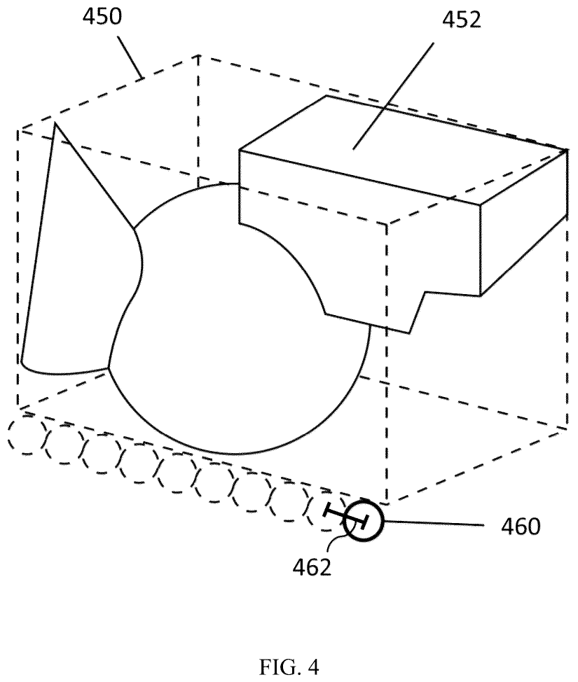

In an embodiment, a resolution step is performed. For example, as depicted in FIG. 4, a resolution may be specified or selected as a variable. A user may input a needed level of detail by specifying a number of vertices or by selecting predefined semantic levels of detail (i.e., low, medium, or high) for the system to determine the number of vertices appropriate for the selection based on a model complexity. That is, a more complex model will typically require a larger number of vertices to achieve a certain level of detail. A desired number of vertices in relation to the bounding box size 450 and surface area 452 may be used to calculate an average distance 462 between a pair of vertices 460 needed to provide the required level of detail. The distance 462 between a pair of vertices 460 may be referred to as a “resolution step” 462 and may be used as a variable in further aspects as described herein.

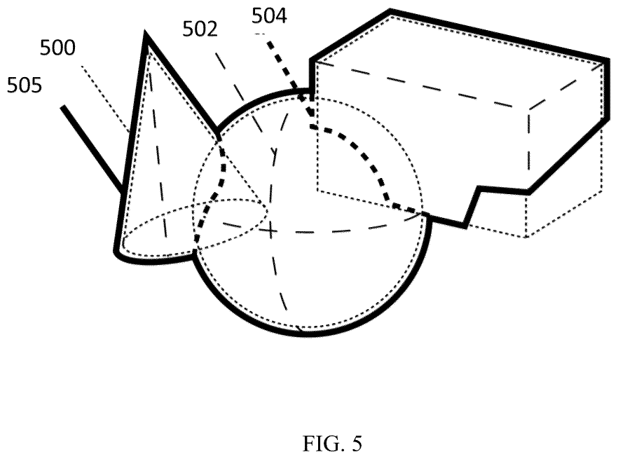

For the purposes of better shape approximation and faster processing, the systems and methods may advantageously include a segmentation aspect. For example, as depicted in FIG. 5, an analytical surface 505, or model, stores inside the primitive shapes 500 it was constructed with. Each primitive shape may have intrinsic axes 502. Additionally, lines 504 at the joints between primitive shapes 500 may be defined to form closed edge loop areas.

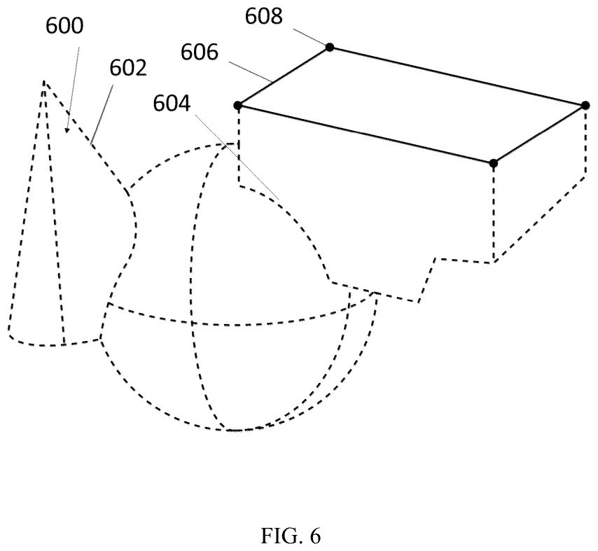

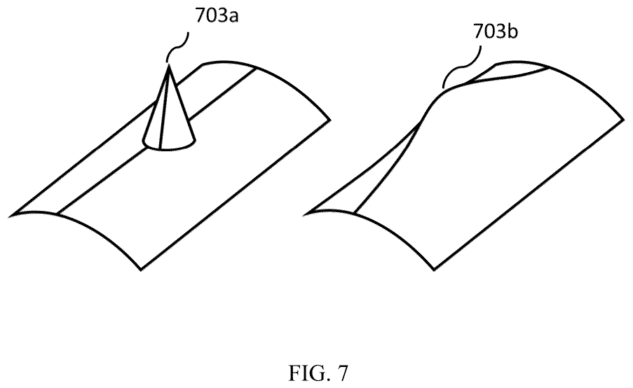

The lines or boundaries, along with the underlying primitive shape, define new “shells” 600 as depicted in FIG. 6. The shells 600 are generally defined by the lines or boundaries. Each shell 600 generally has a list of the contained edges 606 and joint points 608. Therefore, the joint points are a special case of a vertex but are nonetheless used as vertices in creating a final model. However, if a shell is significantly less in size than the resolution step (e.g., 162), it may be filtered out, as depicted in FIG. 7. For example, a small feature or primitive shape 703a may, depending upon the resolution step, be partially or fully smoothed or filtered 703b. As a result, shells that are significantly less in size than the resolution step will be filtered out while potentially having an attenuated influence on the overall shape.

Referring again to FIG. 6, a shell 600 is an area formed by a closed loop of 3 or more primitive axes 602 joining or crossing one another. The axes of each primitive are generally pre-determined to sufficiently define the shells. A border point 608 is a vertex which is generally created where one primitive axis joins or crosses another primitive axis from the same or another primitive. Every primitive generally contains axes, including rotating surfaces (e.g., a sphere or cylinder) and non-rotating surfaces (e.g. a rectangle). A rotating surface may have an axis every 90 degrees of rotation in a rotation plane. For example, a sphere may have 8 shells with a generally triangular shape with slightly convex edges, and a cylinder may have 12 shells (four shells as convex rectangles along its length, and four generally triangular shells at each end). However, it can be appreciated that primitives can be defined with an appropriate number of axes as necessary.

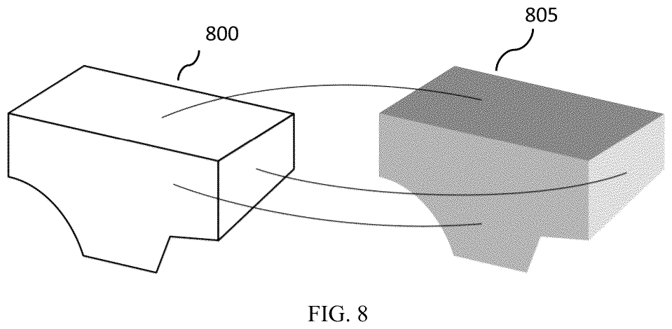

In an embodiment, the edges that comprise each shell are first extracted. Every object, such as a shell, is an analytical surface that may have various modifications and/or sculpting. As a result, the location of each edge may be stored in a non-discrete manner and may instead be sampled at the given level of detail by following at least one of the steps as depicted in FIGS. 8 through 10.

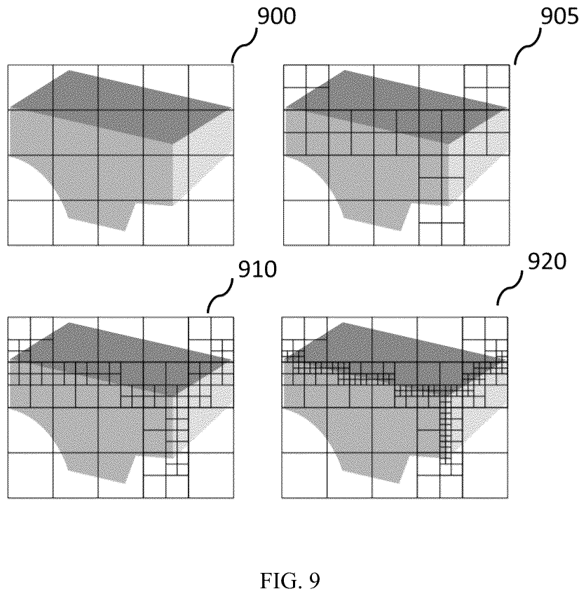

FIG. 8 depicts a step of defining an area formed by intrinsic axes of a given primitive. For example, a shell 800 may be defined as an area 805 which is then analyzed to extract one or more edges. FIG. 9 depicts an exemplary step of an analysis. First, the entire object may be placed inside of a subdivision grid in a two-dimensional unfolded surface of each primitive and/or three-dimensional space of the whole object. For example, the three-dimensional object may be placed in a grid 900. Each sector of the grid is subdivided until a condition is met. The condition may be that only one value and identifier are filling it, or that the sector size is less than or equal to a sampling value. The process of sector subdivision is shown gradually in 905 and 910, followed by 920.

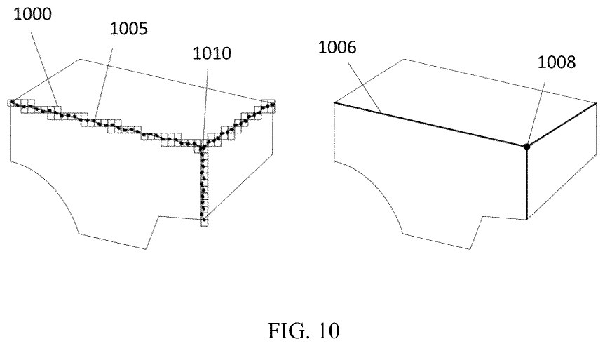

As depicted in FIG. 10, a filtering may then be applied to remove all but the smallest subdivided sectors 1000 still having two or more values and identifiers inside of them. A point may be placed at the center of each sector left after filtering, and values and identifiers relevant to the parent sector may be stored for each point. Any points having the same two values and identifiers 1005 are clustered to form edges 1006. Any points having the same three or more values and identifiers are clustered to form joint points 1008, which may be flagged as corner points of the shell for subsequent steps or processes.

When one primitive intersects another the joint line is formed (e.g., joint 604 in FIG. 6). This joint line has several axes inherited both from the protruded and protruding primitives. For example, as depicted in FIG. 6, a cone protruding a sphere will give a joint line having 4 axes created by 4 shells making up a cone surfaces. Generally, each part of the joint line is a projection of a protruding shell on a protruded shell.

In order for the final model to undergo retopology into quads, the number of joint points for each shell must be at least four, and must be an even number. While it should be appreciated that certain embodiments could utilize a triangular mesh, a quad mesh it preferred. A quad mesh has several advantages including better appearance, better rigging and animation, it allows for dynamic subdivision if needed, and allows for other software to build instruments on the quad(s). Therefore, an overall number of vertices for the entire mesh (and each shell) must be an even number. Otherwise some parts would not connect in the end because there will be not enough (or more than needed) vertices to form the quad mesh.

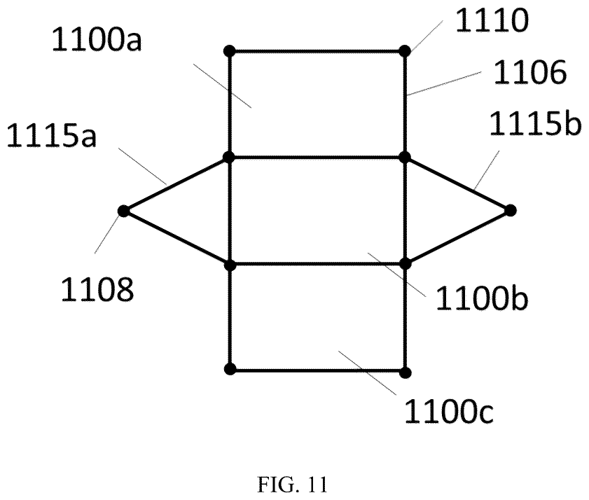

When a primitive contains an odd number of joint points, such as with triangular shells of a primitive (see FIG. 11), an odd number problem is introduced. In the case of prism there will be a 3 rectangular (sides) and 2 triangular (caps) shells. For example, FIG. 11 depicts a minimal resolution prism which would have 3 quad or rectangular shells (1100a, 1100b, 1100c) and 2 triangle shells (1115a, 1115b). The example of FIG. 11 is “minimal resolution” because the distance between the joint points 1110 is generally not large enough to require additional joint points. However, because triangles cannot be used in quads, one point must be added to each of the triangles to make it quad. Since each shell shares its borders with other shells adding a point to one shell will affect a neighbor shell as well. In the case of a prism adding a point to a triangular shell will automatically add a point to the neighbor rectangular shell effectively making it an odd numbered shell. This requires adding one more point to this odd numbered rectangle to make it even numbered again. Which in turn will affect one of its neighbors. Clearly, this process can become infinite unless a solution is provided.

Mathematically, for each odd-numbered shell (e.g., 1115a) there will be another odd-numbered shell (e.g., 1115b). Therefore, if a point is added to an edge of both triangles 1115a and 1115b shared with an adjacent rectangle, this will effectively make triangles even and a rectangle will remain even too, just with two additional points. While this solution works for a simplified minimal resolution prism, more complicated models require a more sophisticated solution.

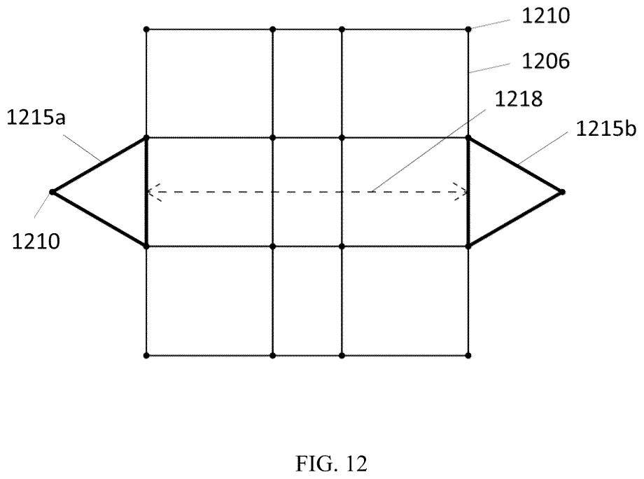

FIG. 12 depicts a model projected onto a plane, the model having a first 1215a and second 1215b shells having an odd number of joint points 1210. Shell border points 1210 are placed on the border edges 1206. In an embodiment, the border points 1210 are placed one resolution step from each other. In an embodiment, the border points 1210 are placed approximately one resolution step from each other with some margin of misplacement. In an embodiment, the margin of misplacement may be pre-defined.

As alluded to in the foregoing, it would no longer be sufficient to place one point on a border of each triangular shell 1215a and 1215b because this would result in two rectangular shells directly adjacent the triangles having an odd number of vertices. Therefore, a solution is required.

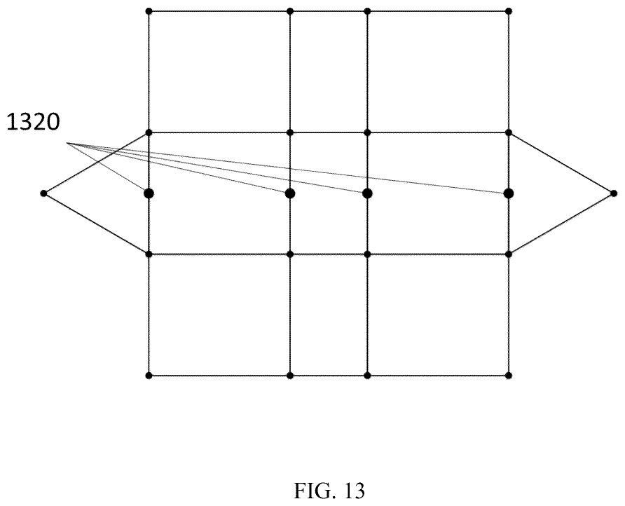

Provided for is such a solution. A shortest route from an edge of one shell having an odd number of joints to another shell having an odd number of joints may be determined. For example, a shortest route 1218 from a first 1215a to a second 1215b shell having an odd number of joints may be determined as depicted in FIG. 12. The shortest route 1218 places a vertex 1320 on each edge that it crosses, as depicted in FIG. 13. In an embodiment, the shortest route 1218 has to cross the edges (e.g., 1215a and 1215b) at a point that is at least one resolution step away from the joint points of said edges. The shortest route provides the default level of detail because the points added to account for shells having an odd number of shells are required in order for there to be eventual quad retopology of the model. That is, in cases where an odd number of joint points are present in a shell, the resolution step may be determined by the default level of detail.

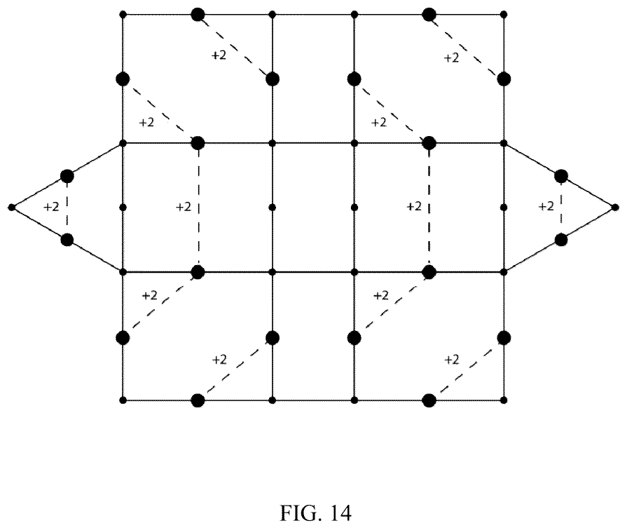

As depicted in FIG. 14, points may also be placed along the border edges of each shell following the resolution step which was set by the default level of detail (such as by the shortest route 1218 if odd shells were present). In an embodiment, the number of points on the border edges must remain even, and the system adds points incrementing their number by two or by any multiple of two.

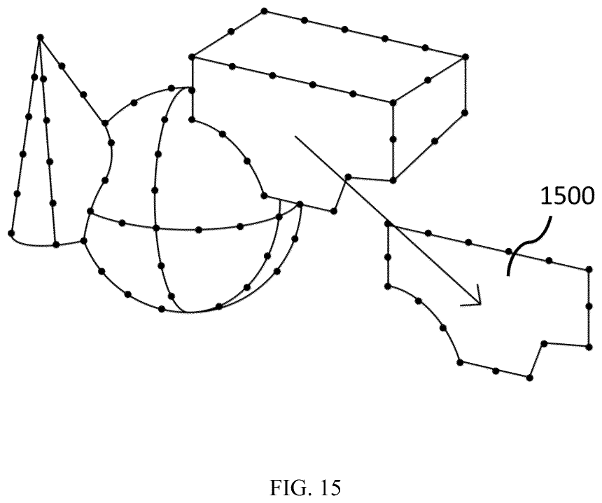

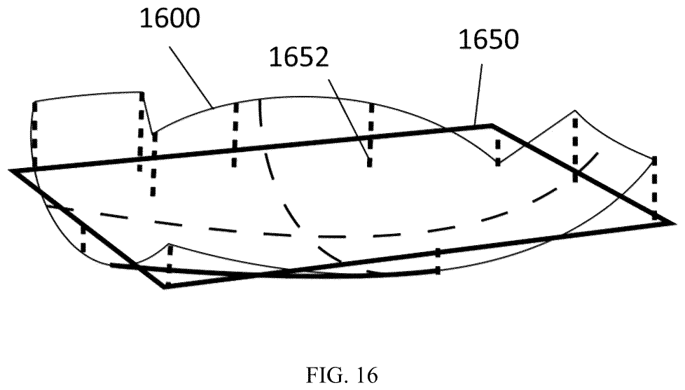

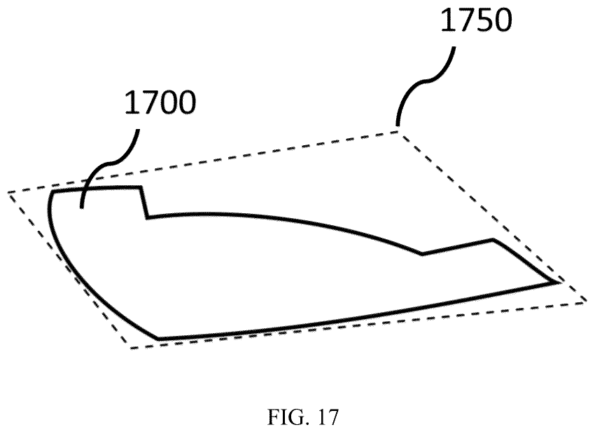

Once border points have been defined for each shell 1500, the shells 1500 may be separated as depicted in FIG. 15. The shells 1500 may be 3-dimensional. In an embodiment, the shells 1500 are further processed in 3-dimensional format. In an embodiment, the shells 1500 are flattened to two dimensions. Advantageously, flattening the shells 1500 to two dimensions may save computing resources. An exemplary shell flattening procedure is depicted in FIG. 16. The shell 1600 may be projected on a rectangular plane 1650. Generally, the shell 1600 is positioned such that its points 1610 are normal 1652 to the rectangular plane 1650. In an embodiment, the shell 1600 is positioned to minimize the aggregate value of normal 1652 vectors of the shell 1600. FIG. 17 depicts a flattened shell 1700 on a rectangular plane 1750. In general, each flattened shell 1700 may be processed further individually. In an embodiment, one or more flattened shells 1700 are processed in parallel.

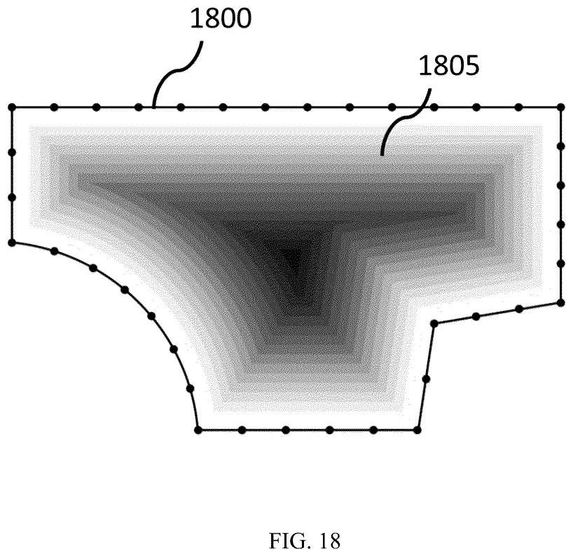

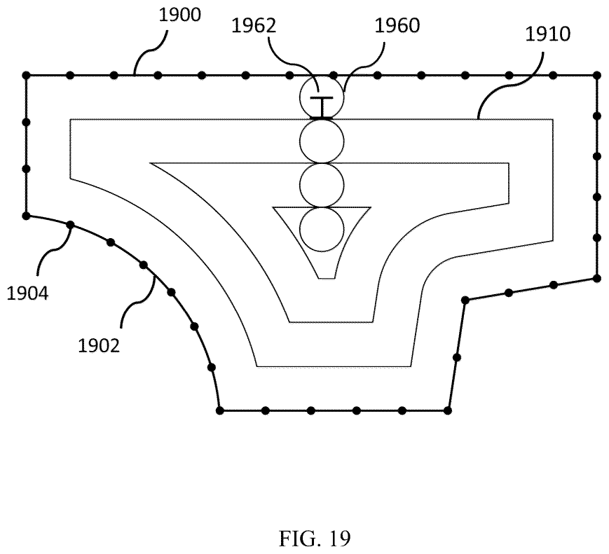

Isolines will generally be created in each shell or flattened shell. Isolines are concentric lines inside the respective shell, with one resolution step in-between the lines. The term “concentric” means that the lines follow the shape of the outer border of the shell or flattened shell (see, e.g., FIG. 19). In an embodiment, a heat map 1805 is created in a given shell 1800, as depicted in FIG. 18. A heat map 1805 is a gradient from the edges to the center of a given shell. A heat map 1805 may be used to obtain geometric distances to create isolines. In an embodiment, isolines are created by use of a heat map 1805. In alternative embodiments, a different operation is used to generate isolines, such as an optimization or fitting procedure.

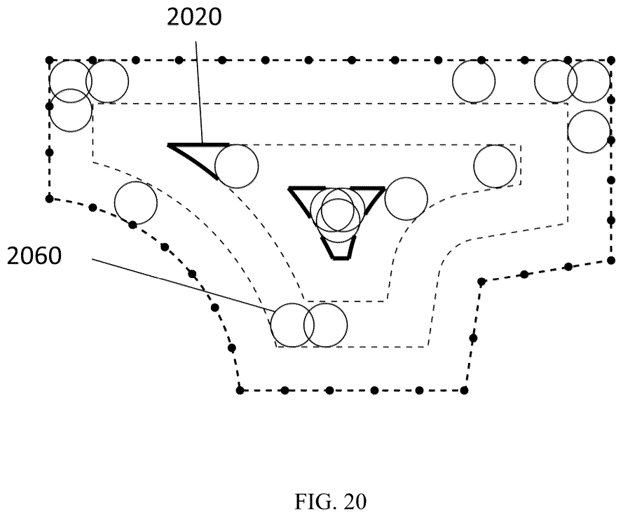

FIG. 19 depicts a flattened shell 1900 (or alternatively a shell if no flattening was required or performed) with concentric isolines 1910 added. The isolines are spaced one resolution step apart, as indicated by the radius of markers 1962. The shell 1900 will generally have a border 1902 and border points 1904 separated by a resolution step. As depicted in FIG. 20, once the isolines have been added, markers 2060, which are shapes representing the resolution step, are placed surrounding the respective isolines. In an embodiment, markers are circular in shape with a diameter of the resolution step. In an embodiment, markers may be allowed to overlap. Generally, in complex shell shapes, there will be one or more regions 2020 where a marker 2060 will not fit. In order to retain these features, they are advantageously collapsed into lines which will be further useful for compression, decompression, and meshing procedures.

It should be appreciated that the described procedures in the foregoing and following description can be performed by various sequential steps, or by various iterative steps. For example, the resolution step may be varied or modified depending upon a final result or an intermediate result. Generally, a person of skill in the art will appreciate various manners in which the disclosed steps and procedures may be applied and/or combined.

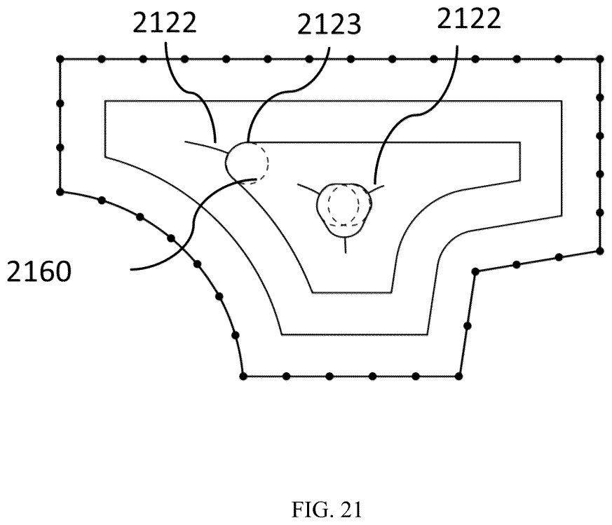

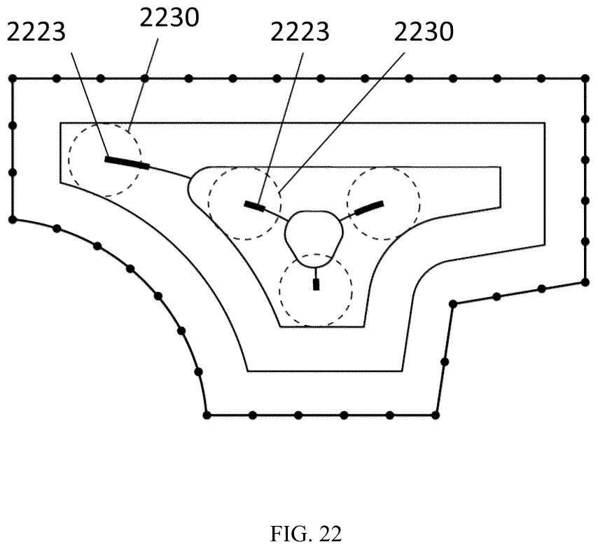

FIG. 21 depicts an embodiment having features smaller than a marker 1860 being collapsed into lines. The marker 2160 which was originally placed as closely as possible to the feature (see FIG. 20) now provides a portion of the border 2123 for the isoline, with a line 2122 extending from the center of the marker to the outermost or most distant point of the feature relative to the center of the marker. In an embodiment, the line 2122 is straight. In an embodiment, the line 2122 is curved. In an embodiment, the line 2122 is an arc. In an embodiment, the line 2122 has any suitable profile or is generated to generally bisect the feature. The length of the line may vary but is generally dependent upon the next largest isoline as depicted in FIG. 22. In an embodiment, the line has an end point 2223 which terminates the line to set its length. In an embodiment, the length of line is set by placing the endpoint 2223 within a circle 2230 aligned within the next largest isoline. See, for example, FIG. 22. The size of the circle 2230 may be pre-set or variable. In an embodiment the radius of the circle 1930 is dependent upon eqn. 1:

$$R = ( ResolutionStep * 0.8 ) * 2 \qquad Equation 1$$

In an embodiment, the radius of the circle 2230 is greater than or equal to a radius of a marker (e.g., 2060 or 2160). In an embodiment, the radius of the circle 2230 is greater than a radius of a marker.

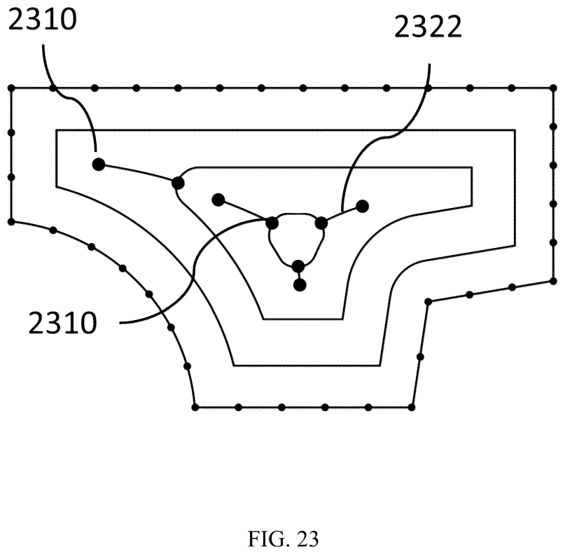

As depicted in FIG. 23, vertices are placed at the tip and base of the collapsed lines. These vertices are marked as extreme points 2310 for later use.

The following steps include exemplary procedures to complete population of the shell with vertices for subsequent meshing of the shell. While the following First and Second exemplary procedures are included as separate examples, it should be appreciated that the described concepts may be utilized in additional procedures within the spirit and scope of the present disclosure.

### First Exemplary Procedure

In a first exemplary procedure, one or more of the following steps may be included.

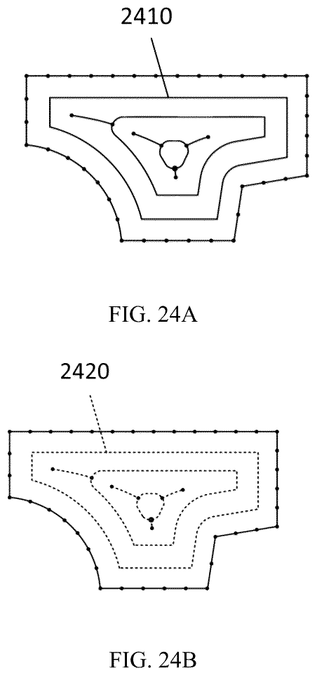

One or more concave extremes may be determined for a given shell. For example, as depicted in FIG. 24A, the isolines 2410 may be seeded with sampling points, as depicted in FIG. 24B. The sampling points will generally be placed one resolution step away from each other along the isoline. In an embodiment, the sampling rate is determined for each isoline according to the formula:

$$Sampling Rate = Resolution Step / Isoline Length in Resolution Steps \qquad Equation 2$$

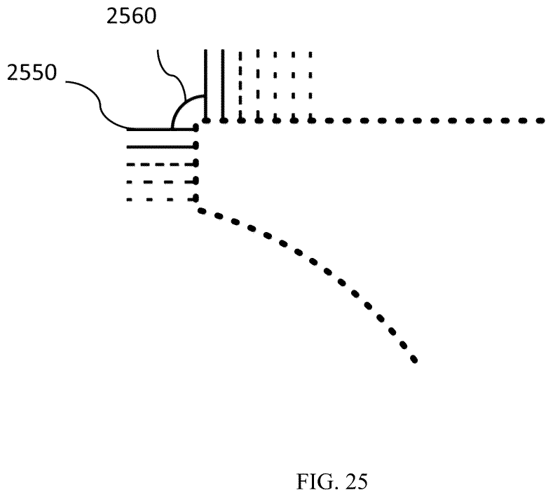

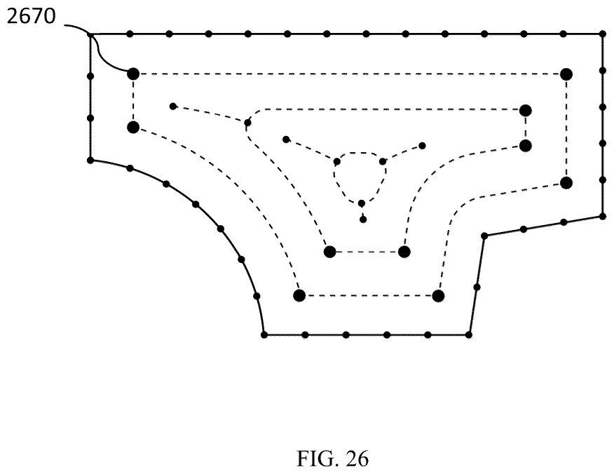

For each sampling point, the curvatures between it and its neighbors are determined. For example, as depicted in FIG. 25, a line 2550 normal to the isoline may be utilized at each sampling point. The angles 2560 between lines 2550 can then be utilized to determine the curvature between the two respective sampling points. If a sample point angle 2560 is both greater than ¼π (i.e. 0.25*pi), and greater than the two closest neighboring angles, then this sample point will be considered a concave extreme. The concave extremes 2670 are placed everywhere these conditions have been met, as depicted by FIG. 26.

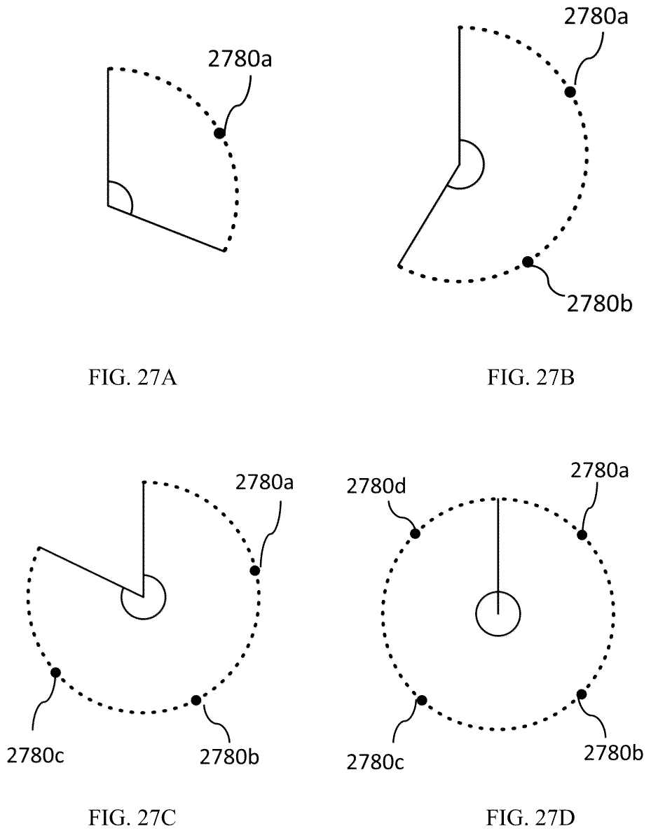

One or more convex extremes may be determined for a given shell. In an embodiment, sections of isolines between concave extremes are processed to find convex extremes. In an embodiment, the sections of the isolines between concave extremes are processed in the same way, but in reverse order, to find convex extremes. For example, the angles between sample points inside every section between concave extremes of the isoline may be summed to calculate an overall angle of the given section. In an embodiment, if an overall angle is greater than π/2 (i.e. pi/2), one convex extreme will be added to the section. In an embodiment, if an overall angle is greater than π (i.e. pi), two convex extremes will be added. In an embodiment, if an overall angle is greater than 3π/2 (i.e., 3*pi/2), three convex extremes will be added. In an embodiment, if an overall angle is 2π (i.e., 2*pi), four convex extremes will be added. Example representations of these four scenarios are depicted in FIGS. 27a-d, respectively, where the one (2780a), two (2780a-b), three (2780a-c), or four (2780a-d) vertices shown on the dashed line represent convex extremes to be added.

Once the number of convex extremes to be added has been determined for an isoline, their placement points are determined. In an embodiment, convex extreme placement point is defined by the formula:

$$Convex Extreme Placement Point = Overall Secton Angle / of Convex Extremes + 1 \qquad Equation 3$$

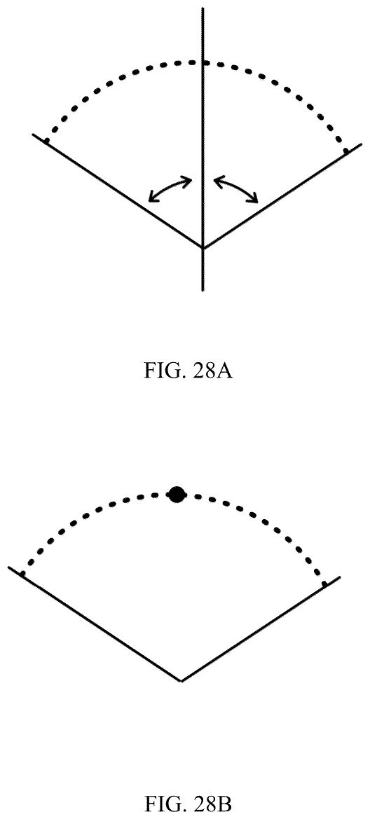

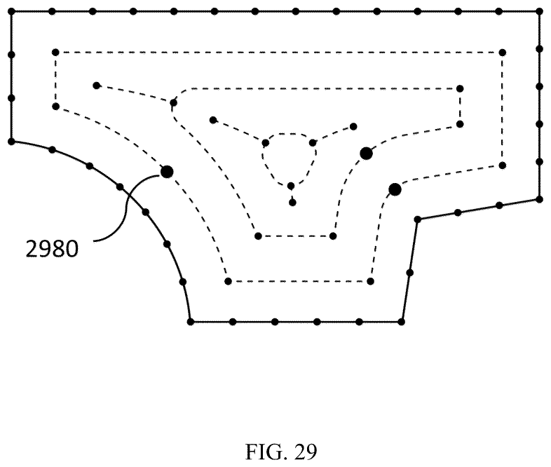

Following equation three, each convex extreme is placed where the overall angle has reached the number defined by the formula starting either from the beginning of the section, or from the previous convex extreme. An example of this process is depicted in FIG. 28A-B. The convex extremes 2980 are then placed on the isolines accordingly, as depicted in FIG. 29, where the placed convex extremes are shown as larger dots for emphasis. In an embodiment, unlike concave extremes, the convex extremes 2880 may not be used as vertices for the quad mesh, but will influence vertex connection around them.

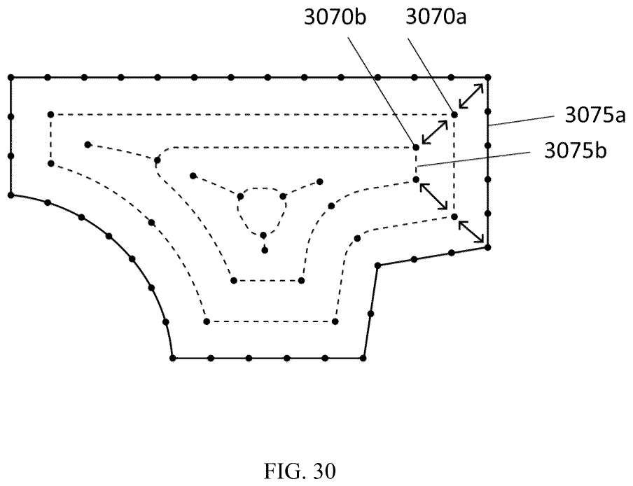

Once the convex extremes, concave extremes, corner points of the shell, and extreme points on the tips of the collapsed areas have been placed on the shell, they can then be grouped into pyramids for a pyramid segmentation procedure. As shown in FIG. 30, grouping into pyramids involves a relationship between outer, parent isolines 3075a and inner, child isolines 3075b. Connections are made between concave extremes on a child isoline (e.g., 3070b) and concave extremes on a parent isoline (e.g., 3070a). In an embodiment, the process starts from the extremes on a parent isoline, which will be the bottom of the pyramid, and end at the extremes on the child isoline, which will be the top of the pyramid.

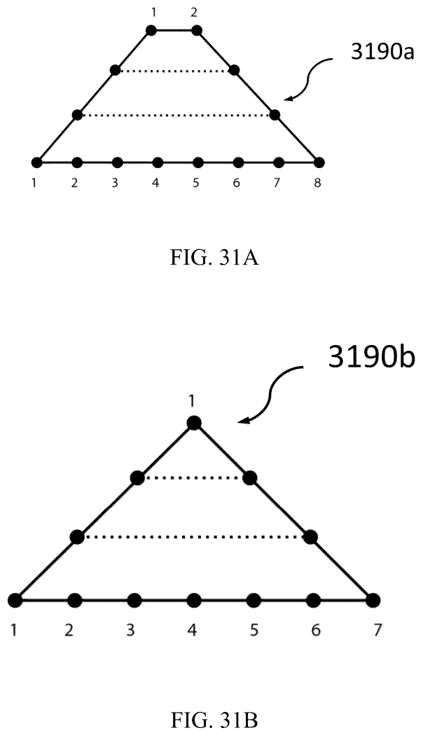

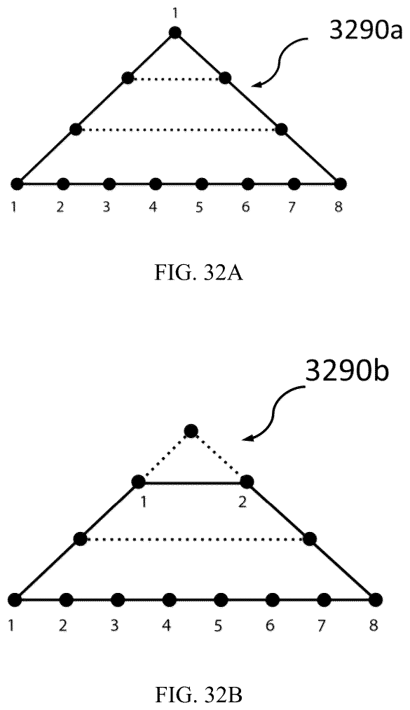

This pyramid segmentation process may include one or more rules. For example, the vertex number (i.e., number of vertices) between extremes is checked for the bottom segment of the pyramid. Generally, bottom segments which have even number of vertices must have top segments with even number of vertices, as exemplified in pyramid 3190a of FIG. 31A. Likewise, bottom segments which have an odd number of vertices must have top segments with an odd number of vertices, as exemplified in pyramid 3190b of FIG. 31B. If the extremes were connected such that the bottom of the pyramid has an even number of vertices and the top has an odd number of vertices, as depicted in FIG. 32A; 3290a, then the pyramid will be reconnected using a parent section as depicted in FIG. 32B; 3290b to result in the top having an even number of vertices.

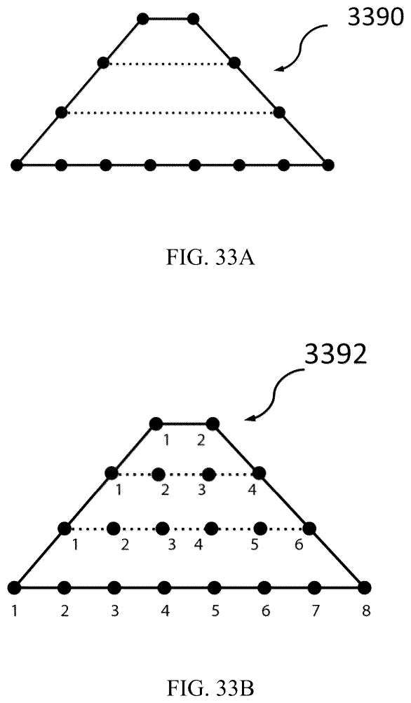

Once one or more pyramids have been created, empty sections of the pyramids may be filled with vertices. In filling the pyramids with vertices, certain guidelines may be imposed. For example, the vertices may be sequentially added from the bottom (outer or parent of the shell) to the top sections (inner or child isolines) of a pyramid. This filling process is shown in FIG. 33A-B. In an embodiment, the number of added points to an upper section is equal to the number of points on the bottom section of the pyramid, or is an even number of points greater than or less than the number of points on the bottom section of the pyramid. In an embodiment, the number of points added to each isoline is an even number of points. In an embodiment, the number of points on a given isoline in a pyramid is B±2*n, where B is the number of points on the bottom section of the pyramid and n is an integer ranging from 0 to a positive integer value (without limitation, n could be, for example, from 0 to 10). The upper bound of n may depend upon several factors and may be any reasonable value to for the procedure being followed to produce a filled pyramid 3392 from a skeletal pyramid 3390. In the case where a convex extreme is present, it may be ignored for the purposes of having an even number of points on an isoline (that is an isoline may have, for example, four vertices and one convex extreme without breaking the even number of vertices requirement).

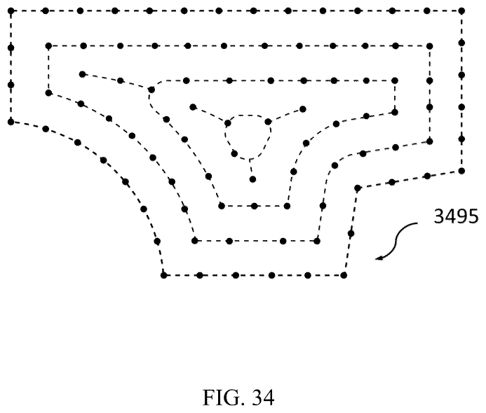

Pyramids are generally created until there are no unconnected extremes left and all of the isolines are populated with vertices. In an embodiment, the pyramids are generated one at a time until all isolines of the shell are populated with vertices. In an embodiment, one or more of the pyramids are generated simultaneously. In an embodiment, the pyramids generated may overlap at one or more points. In an embodiment, the pyramids generated may not overlap at one or more points. Once all of the isolines of the shell have been populated with vertices, as depicted in the populated shell 3495 of FIG. 34, the populated shell may be utilized for meshing procedures. While the pyramids are not depicted on FIG. 34, the underlying pyramid information may be stored for meshing procedures.

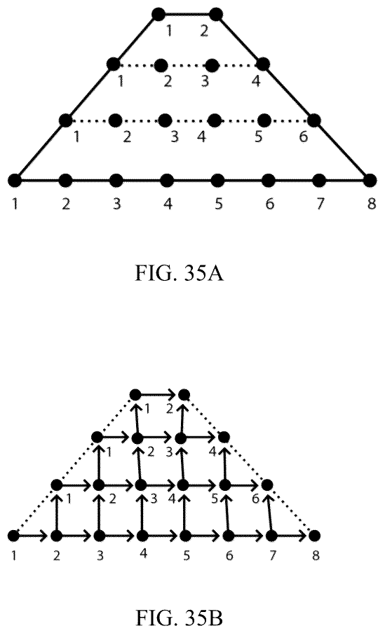

Meshing is performed by connecting the vertices inside every pyramid according to a procedure. In an embodiment, the meshing procedure includes connecting indexed vertices, where the vertices are indexed sequentially in each bottom, top, or isoline as depicted in FIG. 35A. The meshing procedure may use a formula where a vertex having an index number N on the bottom segment is connected to a vertex having an index number N+1 on the same segment, and to the vertex having index number N−1 on the adjacent (upper) segment. If a vertex with a required index number for the connection cannot be found, then the connection may be ignored.

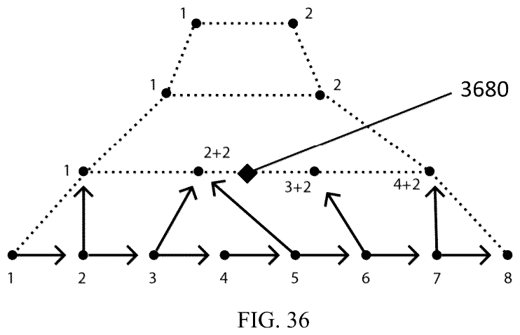

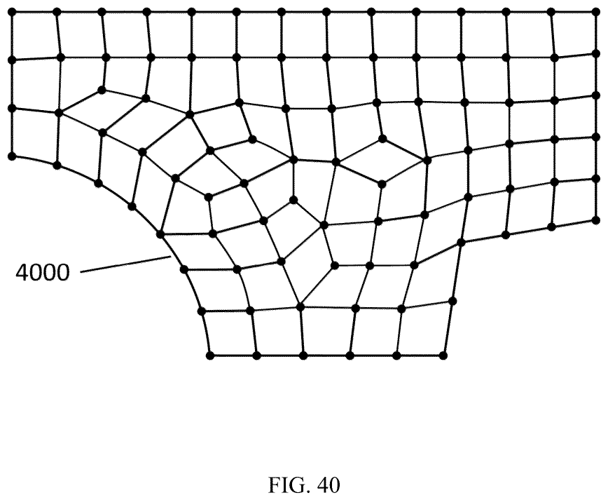

As stated previously, convex extremes may influence the connectivity of the mesh around them. An example of this process is depicted in FIG. 36, where convex extreme 3680 is shown amongst other vertices of the pyramid. Where a convex extreme 3680 is present on a given segment/isoline, the index number of the vertex immediately preceding it will be increased by two, and all vertices following it will have their index numbers increased by two. As shown in FIG. 36, this results in the convex extreme influencing the connectivity of the mesh. Accordingly, the vertices will be connected into quads as depicted in FIG. 40 to produce a meshed shell 4300. The pyramid and other meshing data may be optionally erased once the meshed shell is produced.

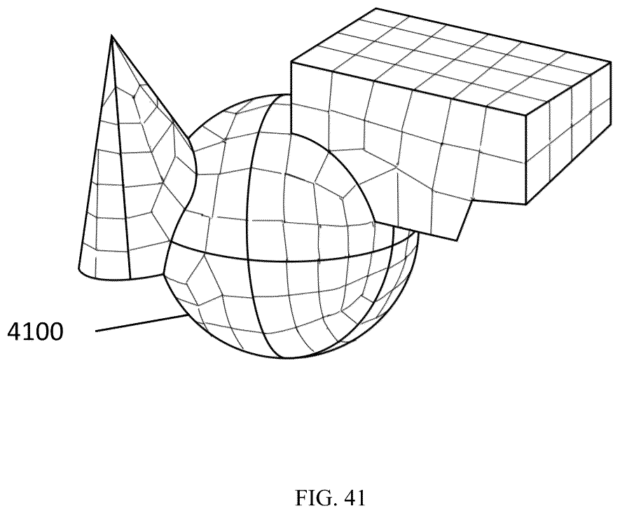

The data stored during the shell flattening procedure may be used to convert any flattened, meshed shells 4000 back to their 3-dimensional shape. Then, the shells can be assembled to generate a full model 4100 as depicted in FIG. 41. The full model can be exported as a quad surface, or optionally as a triangulated surface.

### Second Exemplary Procedure

Other steps to obtain meshed shells may be followed additionally or alternatively. For example, in a second exemplary procedure, one or more of the following steps including compression and/or decompression axes may be utilized.

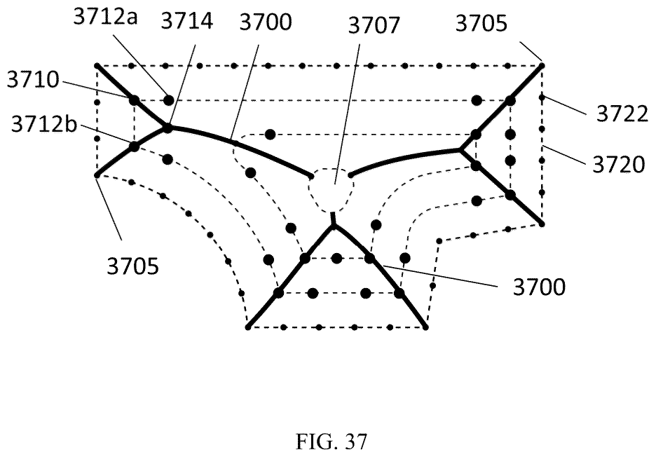

In general, once any necessary lines (e.g., 2322) have been placed, compression axes may be included as depicted in FIG. 37. It should be appreciated that prior to placing the compression axes, the shell border 3720 will have border points 3722 set by the resolution step. However, no isolines will have border points yet. In the following FIGS. 37-39, certain points are emphasized by increasing their size relative to other points—the point size is only to emphasize the described operation and does not have any further meaning.

As depicted in FIG. 37, one or more compression axes 3700 may be determined. The compression axes generally start at any concave points 3705 of the shell border and extend generally toward the center of the shell. Likewise, the compression axes preferably intersect with concave points 3710 of the isolines as they approach the center of the shell. Generally, every compression line places one vertex where it crosses an isoline (such as at concave point 3710), and two adjacent vertices 3712a and 3712b, each one resolution step away from the crossing point 3710. More specifically, for example, point 3712b is also another concave crossing point but satisfies the requirement that there is a point one resolution step from crossing point 3710. Parts of the compression axis which are inside the last edge loop 3707 may be ignored. The axes may generally pass through certain extreme points 3710.

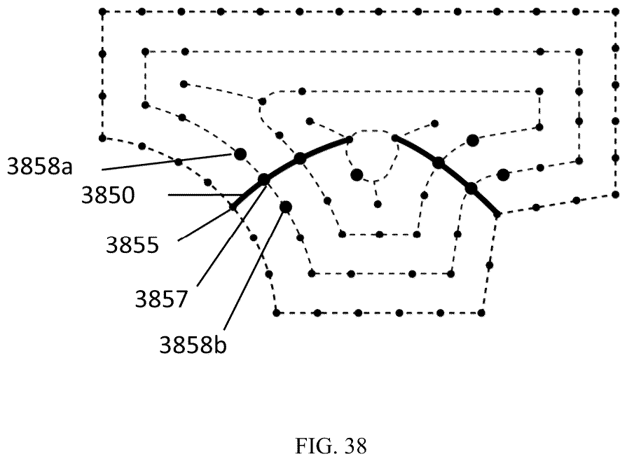

Decompression axes, which are different from compression axes, may also be placed on the shell after compression axes have been determined. FIG. 38 shows an example of adding decompression axes to the embodiment of FIG. 37. For decompression axes or lines 3850, the accumulated change of angle for the parts of the outer edge sitting between the compression axes 3700 (referring to FIG. 37) may be calculated. For the purposes of calculating an accumulated angle, a procedure similar to that of FIG. 27 may be determined. If the accumulated angle change is more than a certain pre-determined or calculated amount in degrees (e.g., FIG. 28), then the line will go out to the point closest to the extremum 3855 of the given part of the outer edge to the point on the last edge loop closest to the center of this loop. In general, this means that decompression axes 3850 may be placed at areas of relatively high curvature 3855 and extend through high curvature areas of the isolines as it approaches the center. Every such decompression line 3850 places one vertex 3857 where it crosses an isoline and two vertices 3858a, 3858b adjacent to the placed vertex, each one resolution step away from the vertex 3857.

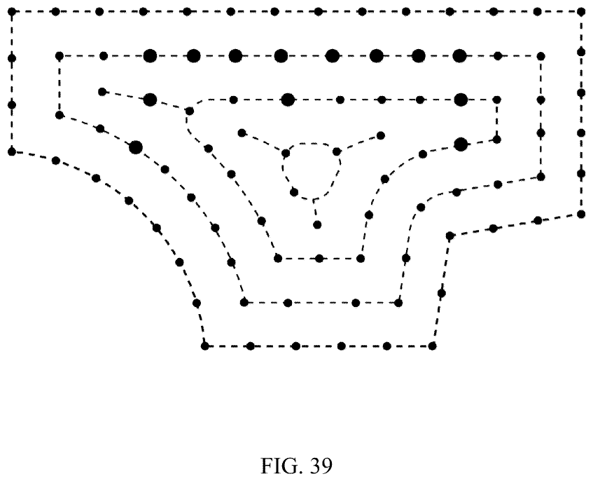

After one or more compression 3700 and/or decompression 3850 lines have been placed on a given shell, meshing may be performed. Continuing from the embodiment of FIG. 38, FIG. 39 depicts an addition of further points or vertices (depicted larger relative to the points previously added by compression and decompression, only for emphasis). The further points are added along each isoline or other line following the resolution step.

As depicted in FIG. 40, the points or vertices are connected with each other using the underlying compression and decompression axis data. The end result is a flattened shell or shell having a quad mesh. This meshed shell 4000 may then be used for reassembly of the overall shape 105. Any required aspects of the foregoing procedure(s) is performed for each shell of the overall shape 105.

The data stored during the shell flattening procedure is then used to convert any flattened, meshed shells 4000 back to their 3-dimensional shape. Then, the shells can be assembled to generate a full model 4100 as shown in FIG. 41. The full model can be exported as a quad surface.

The invention can be embodied in other specific forms without departing from the spirit or essential characteristics thereof. The foregoing embodiments are to be considered in all respects illustrative rather than limiting on the invention described herein. In the various embodiments of the systems and methods of the present invention, where the term comprises is used with respect to the recited elements of the systems or steps of the methods, it is also contemplated that the systems and methods consist essentially of, or consist of, the recited steps or elements. Furthermore, it should be understood that the order of steps or order for performing certain actions is immaterial so long as the invention remains operable. Moreover, two or more steps or actions can be conducted simultaneously.

In the specification, the singular forms also include the plural forms, unless the context clearly dictates otherwise. Unless defined otherwise, all technical terms used herein have the same meaning as commonly understood by one of ordinary skill in the art to which this invention belongs. In the case of conflict, the present specification will control.

What is claimed is:

1. A method for digital content creation, comprising:
overlaying one or more primitive shapes in a first coordinate system, each of the one or more primitive shapes being additive or subtractive, to generate an analytical overall surface defined by subtraction of subtractive primitive shapes from a sum of additive primitive shapes;
determining a resolution step, the resolution step having a geometric magnitude corresponding to a smallest desired feature of the analytical overall surface;
segmenting the analytical overall surface to obtain one or more shells which are geometrically larger than the resolution step, each shell having a border with vertices, the vertices being spaced apart by a distance of about less than or equal to the resolution step;
flattening the one or more shells from three dimensions to two dimensions by projecting the one or more shells onto a respective normal plane aligned on a second respective coordinate system;
generating a number of concentric isolines in the one or more flattened shells;
populating the concentric isolines in the one or more flattened shells with vertices being spaced apart by a distance of about less than or equal to the resolution step;
identifying one or more portions of concave curvature and one or more points of convex curvature in the one or more flattened shells;
meshing the one or more flattened shells to produce meshed, flattened shells by forming connections between adjacent vertices such that the connections between adjacent vertices in the respective flattened shells define respective pluralities of four-sided shapes within the borders of the respective flattened shells, wherein the connections generally pass through portions of concave curvature of the respective flattened shells and wherein the connections generally avoid portions of convex curvature of the respective flattened shells;
unflattening the meshed, flattened shells from two dimensions to three dimensions; and
aligning the meshed, unflattened shells in the first coordinate system to generate a meshed analytical overall surface.

2. The method of claim 1, wherein the concentric isolines of the respective flattened shells are spaced apart by at least a distance of resolution step*2.

3. The method of claim 2, wherein circles having a radius of the resolution step are placed between concentric isolines such that a given concentric isoline does not intersect a given circle at more than one point.

4. The method of claim 3, wherein regions of the concentric isolines of a given shell which are smaller than a circle having a radius of the resolution step are collapsed into line segments defined a start vertex and an end vertex.

5. The method of claim 1, wherein the respective portions of concave curvature include a concave extreme vertex, and wherein the respective portions of convex curvature include a convex extreme vertex.

6. The method of claim 1, wherein the border of each of the one or more shells is defined by line segments terminated by joint points, each joint point being shared by two line segments.

7. The method of claim 7, wherein a shell may have an odd number of joint points or an even number of joint points.

8. The method of claim 7, wherein for every first shell having an odd number of joint points, a second shell having an odd number of joint points is present.

9. The method of claim 8, wherein for every first and second shell having an odd number of joint points, a border point is added on an edge of the first and second shells to produce an even number of points on each of the first and second shells.

10. A system for digital content creation comprising:
a mobile computing device comprising
a processor operably coupled to transitory memory, wherein the processor is operable to obtain computer-readable instructions from a non-transitory data store of the mobile computing device or from a non-transitory data store accessible over a network connection of the mobile computing device, and wherein the processor is operable to load said computer-readable instructions to said transitory memory for execution by said processor;
an application including a graphical user interface comprising user prompts operable to instruct the processor to execute selected computer-readable instructions, wherein the graphical user interface is operable to perform one or more steps of:
overlaying one or more primitive shapes in a first coordinate system, each of the one or more primitive shapes being additive or subtractive, to generate an analytical overall surface defined by subtraction of subtractive primitive shapes from a sum of additive primitive shapes;
determining a resolution step, the resolution step having a geometric magnitude corresponding to a smallest desired feature of the analytical overall surface;
segmenting the analytical overall surface to obtain one or more shells which are geometrically larger than the resolution step, each shell having a border with vertices, the vertices being spaced apart by a distance of about less than or equal to the resolution step;
flattening the one or more shells from three dimensions to two dimensions by projecting the one or more shells onto a respective normal plane aligned on a second respective coordinate system;
generating a number of concentric isolines in the one or more flattened shells;
populating the concentric isolines in the one or more flattened shells with vertices being spaced apart by a distance of about less than or equal to the resolution step;
identifying one or more portions of concave curvature and one or more points of convex curvature in the one or more flattened shells;
meshing the one or more flattened shells to produce meshed, flattened shells by forming connections between adjacent vertices such that the connections between adjacent vertices in the respective flattened shells define respective pluralities of four-sided shapes within the borders of the respective flattened shells, wherein the connections generally pass through portions of concave curvature of the respective flattened shells and wherein the connections generally avoid portions of convex curvature of the respective flattened shells;
unflattening the meshed, flattened shells from two dimensions to three dimensions; and
aligning the meshed, unflattened shells in the first coordinate system to generate a meshed analytical overall surface.

11. The system of claim 10, wherein the user prompts include selecting a first primitive shape, placing the selected first primitive shape, selecting a second primitive shape, and placing the selected second primitive shape.

12. The system of claim 10, wherein the user prompts include sculpting a primitive shape by making a stroke in the graphical user interface to offset an analytical surface of the primitive from a default analytical surface of the primitive.

13. The system of claim 12, wherein the offset is stored as a two-dimensional map in a coordinate system of the primitive.

14. The system of claim 13, wherein the offset includes a plurality of points, each of the plurality of points including an offset direction and offset value.

15. A method for digital content creation, comprising:
overlaying one or more primitive shapes in a first coordinate system, each of the one or more primitive shapes being additive or subtractive, to generate an analytical overall surface defined by subtraction of subtractive primitive shapes from a sum of additive primitive shapes;
determining a resolution step, the resolution step having a geometric magnitude corresponding to a smallest desired feature of the analytical overall surface;
segmenting the analytical overall surface to obtain one or more shells which are geometrically larger than the resolution step, each shell having a border with vertices, the vertices being spaced apart by a distance of about less than or equal to the resolution step;
generating a number of concentric isolines in the one or more shells;
populating the concentric isolines in the one or more shells with vertices being spaced apart by a distance of about less than or equal to the resolution step;
identifying one or more portions of concave curvature and one or more points of convex curvature in the one or more shells;
meshing the one or more shells to produce meshed shells by forming connections between adjacent vertices such that the connections between adjacent vertices in the respective shells define respective pluralities of four-sided shapes within the borders of the respective shells, wherein the connections generally pass through portions of concave curvature of the respective shells and wherein the connections generally avoid portions of convex curvature of the respective shells; and
aligning the meshed shells in the first coordinate system to generate a meshed analytical overall surface.

16. The method of claim 15, wherein the respective portions of concave curvature include a concave extreme vertex, and wherein the respective portions of convex curvature include a convex extreme vertex.

17. The method of claim 15, wherein the border of each of the one or more shells is defined by line segments terminated by joint points, each joint point being shared by two line segments.

18. The method of claim 17, wherein a shell may have an odd number of joint points or an even number of joint points.

19. The method of claim 17, wherein for every first shell having an odd number of joint points, a second shell having an odd number of joint points is present.

20. The method of claim 19, wherein for every first and second shell having an odd number of joint points, a border point is added on an edge of the first and second shells to produce an even number of points on each of the first and second shells.
